(19) United States
(12) Patent Application Publication
(10) Pub. No.: US 2006/0090389 A1
(43) Pub. Date: May 4, 2006

(54) Fishing bait with extensible fishing hook

(76) Inventor: Tsai An, Taichung Hsien (TW)

Correspondence Address: TROXELL LAW OFFICE PLLC;SUITE 1404, 5205 LEESBURG PIKE, FALLS CHURCH, VA, 22041, US

(21) Appl. No.: 11/014,177

(22) Filed: Dec. 17, 2004

(30) Foreign Application Priority Data
Nov. 3, 2004 (TW) 093217577

(51) Int. Cl. A01K 85/02

(52) U.S. Cl. 43/37; 43/35

(57) ABSTRACT

A fishing bait with extensible fishing hook. The fishing bait includes: a main body having an interior space and formed with a first opening and at least one second opening; a slider body slidably disposed in the interior space with one end protruding out from the first opening, the slider body being formed with a first abutting section and a second abutting section; a swinging body disposed in the interior space, one end of the swinging body being pivotally connected with the main body, while the other end of the swinging body being formed with a hook section; and a force application section for making the slider body drive the swinging body to swing from the second opening into the interior space. When the slider body is moved from the interior space toward the first opening, the first abutting section pushes the swinging body, whereby the hook section extends through the second opening out of the main body. Reversely, when the slider body is moved from the first opening into the interior space, the second abutting section pushes the swinging body, whereby the hook section retracts through the second opening into the main body.

### BACKGROUND OF THE INVENTION

The present invention is related to a fishing hook structure, and more particularly to a fishing bait with extensible fishing hook.

A conventional fishing bait is composed of a fake fish body and at least one fishing hook. The fishing hook is fixed on outer side of the fake fish body. A fishing line is connected with the fishing bait for fishing fishes. When attracted by the fishing bait, a fish may suck the fishing bait into its mouth. However, the fishing hook protruding from the fake fish body often makes it uneasy for the fish to suck in the fishing bait. Even though the fish sucks in the fishing bait, the fishing hook often randomly hooks the mouth of the fish to cause greater harm to the fish. Moreover, when pulling or retrieving the fishing line, the protruding fishing hook often unexpectedly hooks other fishes swimming around the fishing bait. Such situation often leads to injury or even death of these fishes. This will result in ruin of ecology.

### SUMMARY OF THE INVENTION

It is therefore a primary object of the present invention to provide a fishing bait with extensible fishing hook for minifying the harm to the fish so as to reduce ruin of ecology.

It is a further object of the present invention to provide the above fishing bait with extensible fishing hook, which can achieve better fishing function.

According to the above objects, the fishing bait with extensible fishing hook includes: a main body having an interior space and formed with a first opening and at least one second opening; a slider body slidably disposed in the interior space with one end protruding out from the first opening, the slider body being formed with a first abutting section and a second abutting section; a swinging body disposed in the interior space, one end of the swinging body being pivotally connected with the main body, while the other end of the swinging body being formed with a hook section; and a force application section disposed between the slider body and the main body for making the slider body drive the swinging body to swing from the second opening into the interior space.

The present invention can be best understood through the following description and accompanying drawings wherein:

### BRIEF DESCRIPTION OF THE DRAWINGS

FIG. 1 is a perspective view of a first embodiment of the fishing bait of the present invention, showing that a fishing line is connected with the fishing bait;

FIG. 2 is a front sectional view of the first embodiment of the fishing bait of the present invention, showing the operation thereof in one state;

FIG. 3 is a front sectional view of the first embodiment of the fishing bait of the present invention, showing the operation thereof in another state;

FIG. 4 is a front sectional view of the first embodiment of the fishing bait of the present invention, showing the operation thereof in still another state;

FIG. 5 is a front sectional view of a second embodiment of the fishing bait of the present invention, showing the operation thereof in one state;

FIG. 6 is a front sectional view of the second embodiment of the fishing bait of the present invention, showing the operation thereof in another state; and

FIG. 7 is a front sectional view of the second embodiment of the fishing bait of the present invention, showing the operation thereof in still another state.

### DETAILED DESCRIPTION OF THE PREFERRED EMBODIMENTS

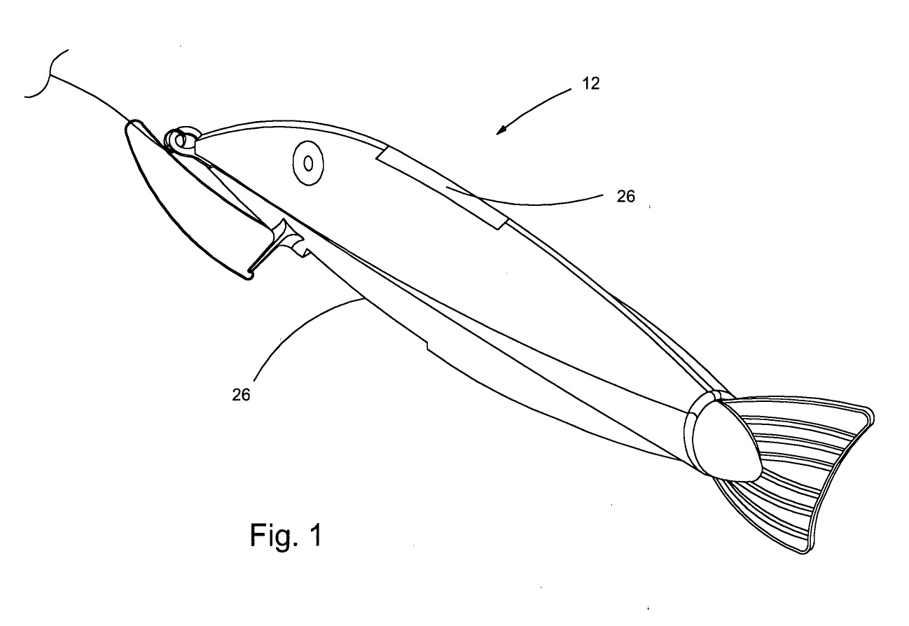

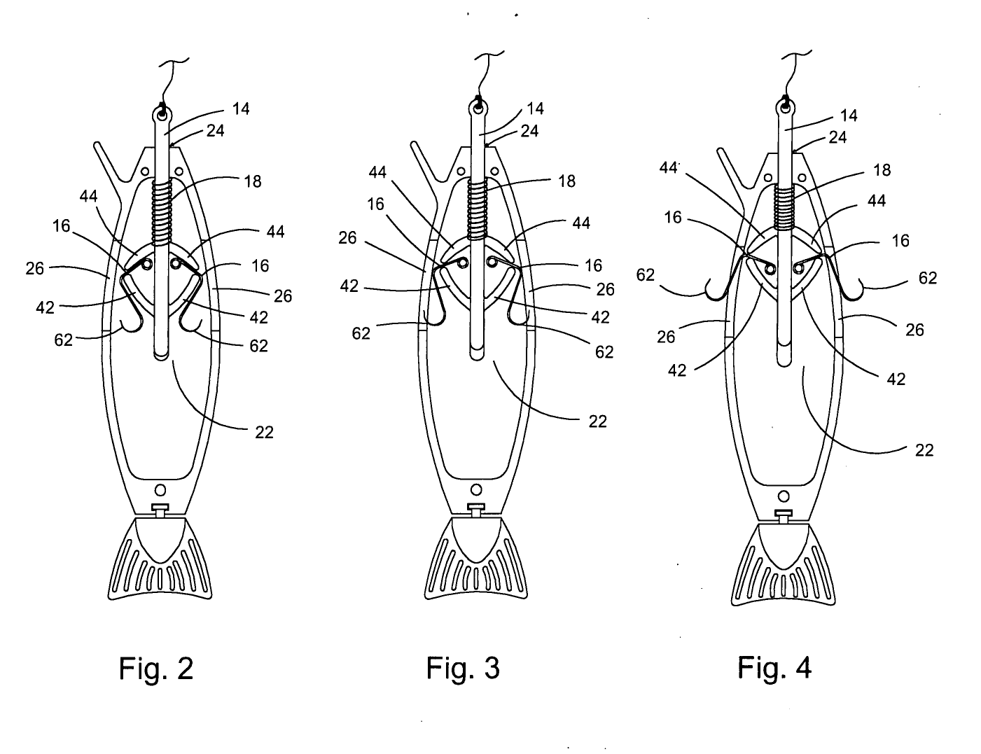

Please refer to FIGS. 1 to 4. The fishing bait with extensible fishing hook of the present invention includes a main body 12, a slider body 14, at least one swinging body 16 and a force application section 18.

The main body 12 has a form of a fish and an interior space 22. The main body 12 is formed with a first opening 24 and at least one second opening 26.

The slider body 14 is slidably disposed in the interior space 22. One end of the slider body 14 protrudes from the first opening 24. The end of the slider body 14 is formed with a hole for connecting with one end of a fishing line. The other end of the fishing line is connected with a fishing rod or a boat body. A first Y-shaped abutting section 42 and a second Y-shaped abutting section 44 outward extend from a middle section of the slider body 14.

The swinging body 16 is disposed in the interior space 22. One end of the swinging body 16 is pivotally connected with the main body 12 and positioned between the first and second abutting sections 42, 44. The other end of the swinging body 16 is bent and extended to form a hook section 62. The swinging body 16 can be pushed by the first and second abutting sections 42, 44 to move between a first position and a second position.

The force application section 18 can be a spring fitted on the slider body 14, whereby the slider body 14 can drive the swinging body 16 to swing from the second opening 26 into the interior space 22.

In use of the present invention, when an external force is not applied to the main body 12 (for example, the main body 12 is bit and pulled by a fish), the force application section 18 makes the second abutting sections 44 push the swinging body 16 to the first position where the hook section 62 is positioned in the main body 12. Under such circumstance, a fish can easily suck in the fishing bait. Also, the inconvenience and danger can be avoided.

When an external force is applied to the main body 12, such as a fish bites and pulls the main body 12, the slider body 14 moves from the interior space 22 toward the first opening 24. At this time, the first abutting section 42 pushes the swinging body 16 to swing from the first position to the second position, whereby the hook section 62 extends from the second opening 26 out of the main body 12 for hooking the fish.

According to the above arrangement, the fishing bait with extensible fishing hook of the present invention has the following advantages:
1. The hidden fishing hook can minify the harm to the fish so as to reduce ruin of ecology.
2. The fishing bait can be designed with a certain size for only fishing a fish with a size corresponding to the fishing bait. This meets the requirement of culture protection.

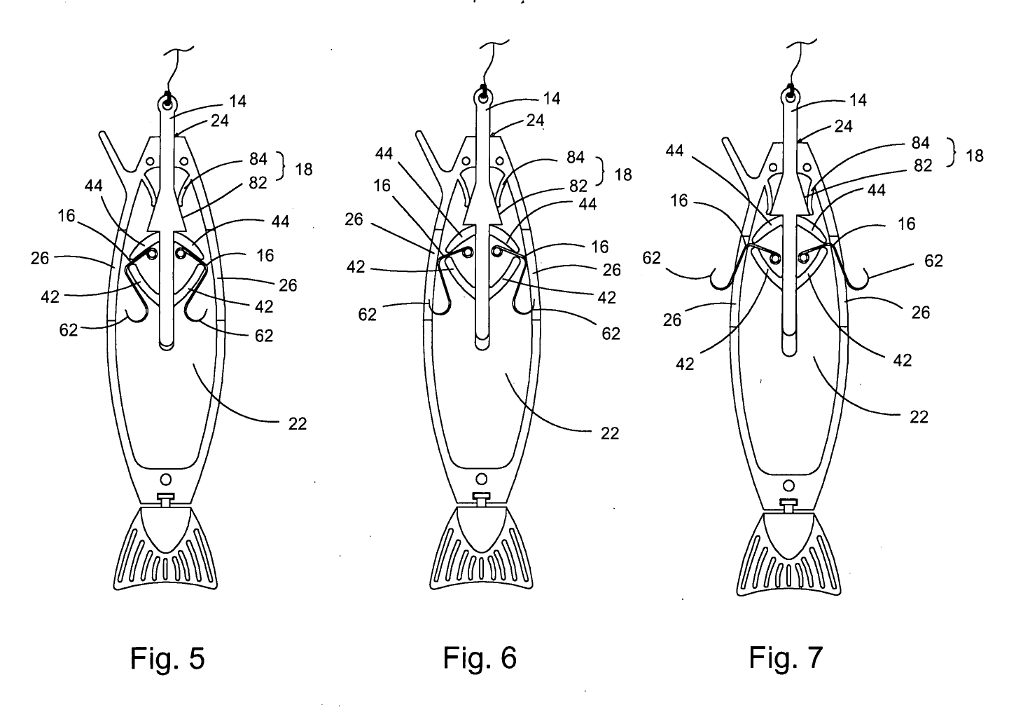

FIGS. 5 to 7 show a second embodiment of the present invention, in which the force application section 18 includes at least one abutting slope 82 and at least one leaf spring 84. The abutting slope 82 is disposed on the slider body 14 between the first opening 24 and the second abutting section 44. The leaf spring 84 is disposed on inner side of the main body 12 corresponding to the abutting slope 82 for pushing the abutting slope 82. Accordingly, the slider body 14 can drive the swinging body 16 to swing from the second opening 26 into the interior space 22. This can achieve the same effect as the first embodiment.

The above embodiments are only used to illustrate the present invention, not intended to limit the scope thereof. Many modifications of the above embodiments can be made without departing from the spirit of the present invention.

What is claimed is:

1. A fishing bait with extensible fishing hook, comprising:
a main body having an interior space, the main body being formed with a first opening and at least one second opening, the first and second openings communicating with the interior space;
at least one swinging body disposed in the interior space, one end of the swinging body being pivotally connected with the main body, while the other end of the swinging body being formed with a hook section;
a slider body slidably disposed in the interior space, the slider body including a first abutting section and a second abutting section, when the slider body is moved from the interior space toward the first opening, the first abutting section pushing the swinging body to swing from a first position to a second position, whereby the hook section extends through the second opening out of the main body, when the slider body is moved from the first opening into the interior space, the second abutting section pushing the swinging body to swing from the second position to the first position, whereby the hook section retracts through the second opening into the main body; and
a force application section for making the slider body drive the swinging body to swing from the second opening into the interior space.

2. The fishing bait with extensible fishing hook as claimed in claim 1, wherein one end of the slider body extends out of the first opening.

3. The fishing bait with extensible fishing hook as claimed in claim 1, wherein the force application section is a spring disposed between the main body and the slider body for making the slider body drive the swinging body to swing from the second opening into the interior space.

4. The fishing bait with extensible fishing hook as claimed in claim 2, wherein the force application section is a spring disposed between the main body and the slider body for making the slider body drive the swinging body to swing from the second opening into the interior space.

5. The fishing bait with extensible fishing hook as claimed in claim 1, wherein the force application section includes at least one abutting slope and at least one leaf spring, the abutting slope being disposed on the slider body between the first opening and the second abutting section, the leaf spring being disposed on inner side of the main body corresponding to the abutting slope for pushing the abutting slope, whereby the slider body can drive the swinging body to swing from the second opening into the interior space.

6. The fishing bait with extensible fishing hook as claimed in claim 2, wherein the force application section includes at least one abutting slope and at least one leaf spring, the abutting slope being disposed on the slider body between the first opening and the second abutting section, the leaf spring being disposed on inner side of the main body corresponding to the abutting slope for pushing the abutting slope, whereby the slider body can drive the swinging body to swing from the second opening into the interior space.

7. The fishing bait with extensible fishing hook as claimed in claim 1, wherein the main body has a form of a fish.

8. The fishing bait with extensible fishing hook as claimed in claim 2, wherein the main body has a form of a fish.

9. The fishing bait with extensible fishing hook as claimed in claim 3, wherein the main body has a form of a fish.

10. The fishing bait with extensible fishing hook as claimed in claim 4, wherein the main body has a form of a fish.

11. The fishing bait with extensible fishing hook as claimed in claim 5, wherein the main body has a form of a fish.

12. The fishing bait with extensible fishing hook as claimed in claim 6, wherein the main body has a form of a fish.
